(19) United States
(12) Patent Application Publication
(10) Pub. No.: US 2016/0111759 A1
(43) Pub. Date: Apr. 21, 2016

(54) BATTERY MODULE

(71) Applicant: NEC ENERGY DEVICES, LTD., Sagamihara-shi, Kanagawa (JP)

(72) Inventors: Yoshiki KOBAYASHI, Sagamihara-shi (JP); Toru SUZUKI, Sagamihara-shi (JP)

(73) Assignee: NEC ENERGY DEVICES, LTD., Sagamihara-shi, Kanagawa (JP)

(21) Appl. No.: 14/781,107

(22) PCT Filed: Apr. 17, 2014
(86) PCT No.: PCT/JP2014/060906

§ 371 Date: Sep. 29, 2015

(30) Foreign Application Priority Data
May 14, 2013 (JP) 2013-102125
Aug. 2, 2013 (JP) 2013-161187

(51) Int. Cl. H01M 10/48; H01M 10/0525

(52) U.S. Cl. CPC H01M 10/486; H01M 10/0525; H01M 10/482

(57) ABSTRACT

Provided is a battery module whose layout for accurately detecting the average of entire temperature information is realized by a small number of temperature sensors.

A battery module 1000 of the present invention is characterized by including a plurality of assembled batteries 600 in which a plurality of unit batteries 100 are sandwiched between two case bodies 601 and 602, wherein slit portions 603 are provided in the assembled batteries 600, and a temperature sensor 886 is disposed between the slit portion 603 of one of the assembled batteries 600 and the slit portion 603 of the other assembled battery 600.

### TECHNICAL FIELD

The present invention relates to a battery module formed by using secondary unit batteries such as lithium-ion batteries.

### BACKGROUND ART

In recent years, lithium-ion secondary batteries that can operate at normal temperature and are high in energy density have gained attention. The lithium-ion secondary batteries are characterized by not only being high in energy density but also being excellent in responsiveness because of low impedance.

As for a battery module formed by using secondary unit batteries such as lithium-ion batteries, demand for high-capacity ones is increasing. What has been frequently used is a plurality of assembled batteries that are connected in series or parallel, with each assembled battery made up of a plurality of unit batteries being connected.

For example, FIG. 9 of Patent Document 1 (JP2003-229110A) discloses a battery module in which a case 10 storing a plurality of secondary batteries 20 is used as one case unit 70, and two case units 70 are stacked and connected.

### Patent Document 1: JP2003-229110A

### SUMMARY OF THE INVENTION

### Problems to be Solved by the Invention

One way to find how much a battery has deteriorated is measuring temperatures. In the case of Patent Document 1, a battery module 21 in which a plurality of secondary batteries 20 are connected in series is stored in a case 10, and one temperature sensor 50 is used to detect the temperature of one secondary battery 20.

In the battery module disclosed in Cited Reference 1, the temperature sensor 50, which is for one second battery 20, needs to be provided for each of the secondary batteries 20, leading to an increase in the number of parts and a rise in costs.

Depending on the way the battery module is used, there is no need to detect the temperature of each unit battery. In some cases, detecting only the temperature of the entire battery module is enough.

In such a case, if the temperature sensors that are mounted as disclosed in Cited Reference 1 are adopted, the problem is that an increase in the number of parts leads to a rise in costs as described above.

In order to reduce the number of temperature sensors provided in the battery module, it is necessary to accurately detect the average of entire temperature information from all the unit batteries that make up the battery module. Therefore, the position where a temperature sensor is disposed is important. However, in the case of the battery module disclosed in Cited Reference 1, the problem is that any information about an appropriate position at a time when the number of temperature sensors is reduced is not disclosed.

### Means for Solving the Problems

The present invention has been made to solve the above problems. A battery module of the present invention is characterized by including a plurality of assembled batteries in which a plurality of unit batteries are sandwiched between two case bodies, wherein slit portions are provided in the assembled batteries, and a temperature sensor is disposed between the slit portion of one of the assembled batteries and the slit portion of the other assembled battery.

### Advantages of the Invention

In the battery module of the present invention, a layout of temperature sensors that can accurately detect the average of entire temperature information from all the unit batteries that make up the battery module can be realized by a small number of temperature sensors. As a result, it is possible to curb an increase in the number of parts and achieve a reduction in costs. Moreover, in the assembled batteries, the unit batteries could swell over time or depending on an environment in which the batteries are used. Even if such swelling occurs, the temperature can be accurately detected.

### BRIEF DESCRIPTION OF THE DRAWINGS

FIG. 1 is a diagram showing an assembled battery 600 that is part of a battery module 1000 according to an embodiment of the present invention.

FIG. 2 is a diagram for explaining how a handle portion 855 and other parts are mounted on an assembled battery housing chassis 800.

FIG. 3 is a diagram for explaining how a second connector 840 is mounted on a connector mounting panel 847.

FIG. 4 is a diagram for explaining how a connector mounting panel 847 is mounted on an assembled battery housing chassis 800.

FIG. 5 is a diagram for explaining a production process of a battery module 1000 according to the embodiment of the present invention.

FIG. 6 is a diagram for explaining a production process of a battery module 1000 according to the embodiment of the present invention.

FIG. 7 is a diagram for explaining a production process of a battery module 1000 according to the embodiment of the present invention.

FIG. 8 is a diagram for explaining a production process of a battery module 1000 according to the embodiment of the present invention.

FIG. 9 is an explanatory diagram showing an overview of a holder 700.

FIG. 10 is a diagram for explaining how a temperature sensor 886 is arranged in a battery module 1000 according to the embodiment of the present invention.

FIG. 11 is a diagram for explaining a production process of a battery module 1000 according to the embodiment of the present invention.

FIG. 12 is a diagram for explaining a production process of a battery module 1000 according to the embodiment of the present invention.

FIG. 13 is a diagram for explaining a production process of a battery module 1000 according to the embodiment of the present invention.

FIG. 14 is a perspective view of a battery module 1000 according to the embodiment of the present invention.

### BEST MODE FOR CARRYING OUT THE INVENTION

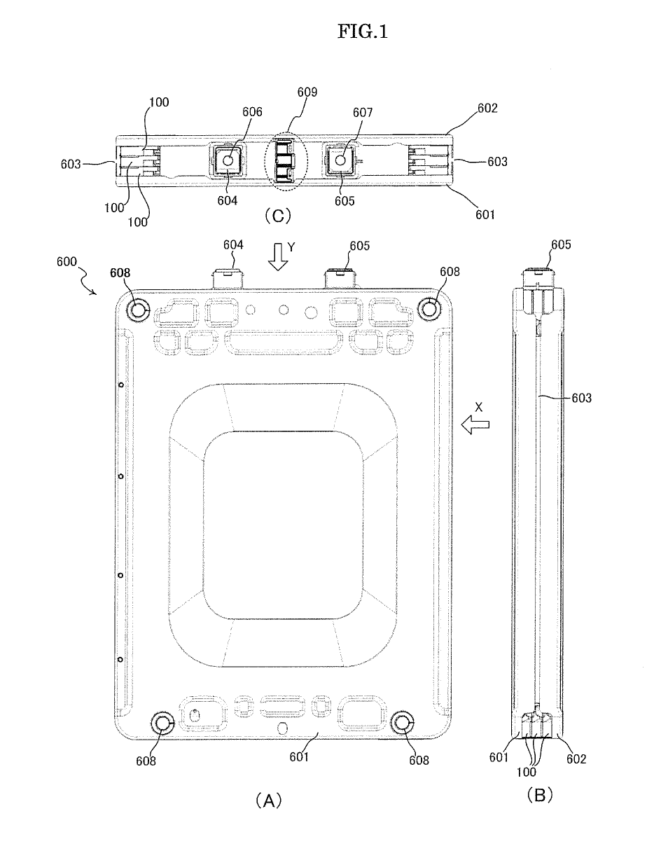

Hereinafter, an embodiment of the present invention will be described with reference to the accompanying drawings. FIG. 1 is a diagram showing an assembled battery 600 that is part of a battery module 1000 according to an embodiment of the present invention. Incidentally, in this specification, the assembled battery 600 is defined as one in which a plurality of unit batteries 100 are connected in series or parallel; the battery module 1000 is defined as one in which a plurality of such assembled batteries 600 are connected in series or parallel.

FIG. 1A is a view of the assembled battery 600 when seen from a direction in which the unit batteries 100 are stacked. FIG. 1B is a view of the assembled battery 600 when seen from X-direction in FIG. 1A. FIG. 1C is a view of the assembled battery 600 when seen from Y-direction in FIG. 1A.

As the unit batteries 100 that make up the assembled battery 600 of the present embodiment, lithium-ion secondary unit batteries, which are one type of electrochemical element, may be used: Charging and discharging take place as lithium ions move between negative and positive electrodes.

A battery body portion of the unit battery 100 is formed in such a way that an electrode stacked body, in which a plurality of sheet-like positive electrodes and a plurality of sheet-like negative electrodes are stacked through separators (not shown), and electrolyte (both not shown) are stored in a laminate film exterior member (not shown) that is rectangular in planar view. From one end portion (side) of the battery body portion, a positive electrode pull-out tab 120 and a negative electrode pull-out tab 130 are pulled out.

In the assembled battery 600 of the present embodiment, four unit batteries 100 are connected in series, and a potential difference of the four unit batteries 100 that are connected in series can be taken out from an assembled battery plus terminal 604 and an assembled battery minus terminal 605. In the assembled battery plus terminal 604 and the assembled battery minus terminal 605, screw holes 606 and 607, which are used to attach the terminals, are respectively provided.

Incidentally, what is described in the present embodiment is the assembled battery 600 that includes four unit batteries 100 being connected in series. However, the number of unit batteries 100 or their connection form is not limited to this.

At a middle point between the assembled battery plus terminal 604 and the assembled battery minus terminal 605, a unit battery voltage take-out connector portion 609 is provided to allow potential of each of assembled batteries 600 that make up an assembled battery 600 to be taken out therefrom. The unit battery voltage take-out connector portion 609 is used to monitor the assembled battery 600.

The four unit batteries 100 that are connected in series are stacked in such a way that main surfaces of the laminate film exterior members (not shown) face each other. The four unit batteries 100 that are stacked are sandwiched between a stainless-steel first case body 601 and second case body 602.

The space of the first case body 601 and second case body 602 serves as a gap; the gap is referred to as slit portion 603.

While the details will be described later, the battery module 1000 of the present embodiment is formed with two assembled batteries 600; a temperature sensor 886 is disposed between the slit portion 603 of one assembled battery 600 and the slit portion 603 of the other assembled battery 600 in order to monitor a temperature of the battery module 1000.

Below is a description of how to produce the battery module 1000 using the above assembled batteries 600, as well as the configuration of the battery module 1000.

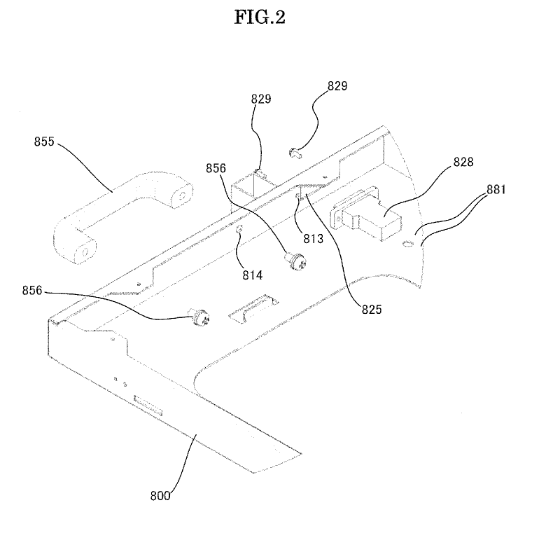

FIG. 2 shows part of an assembled battery housing chassis 800 in which the assembled batteries 600 and other parts are housed. FIG. 2 shows how a first connector 828 and a handle portion 855 are mounted on the assembled battery housing chassis 800.

In the battery module 1000, the first connector 828 is electrically connected to power lines 881. Outside the battery module 1000, a power source of the battery module 1000 can be acquired from a connector, not shown, that is coupled to the first connector 828.

In the battery module 1000 of the present embodiment, the first connector 828 is fitted into a first connector mounting opening 825, and a mounting screw 829 is screwed into a connector mounting screw hole 813. In this manner, the first connector 828 is firmly attached to the assembled battery housing chassis 800.

The handle portion 855 is firmly attached to the assembled battery housing chassis 800 as mounting screws 856 are screwed into handle mounting screw holes 814. The handle portion 855 helps improve the handling of the battery module 1000.

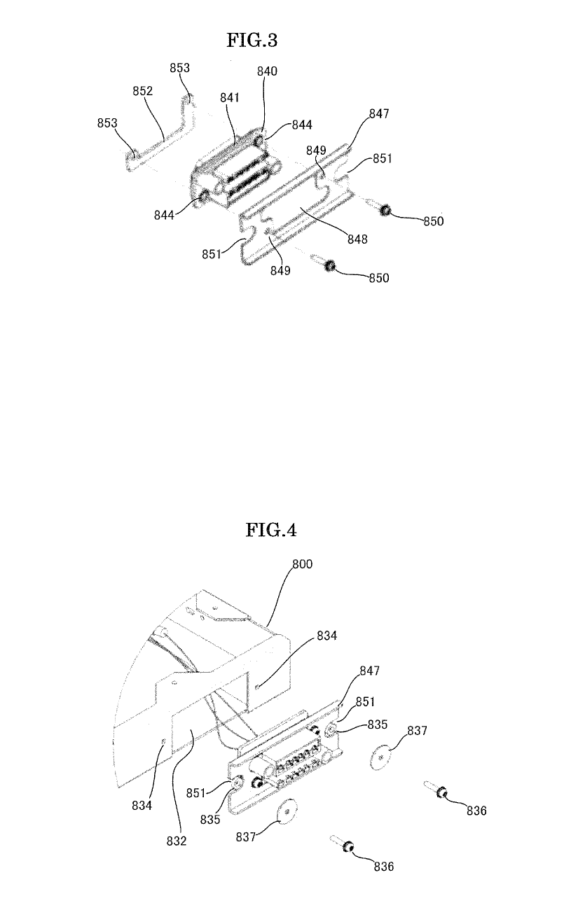

FIGS. 3 and 4 show a production process pertaining to a second connector 840. From the second connector 840, potential information of each of the unit batteries 100 that are connected in series inside the battery module 1000, and information about temperature inside the module can be taken out. Based on the potential information of each unit battery 100, a battery management circuit unit (not shown), which will be described later, is able to manage each unit battery 100 and to perform other operations.

When the battery module 1000 of the present embodiment is mounted in an electrical storage device (not shown), the position of the battery module 1000 is regulated by a rail member (not shown), and the battery module 1000 is fitted into an electrical storage device-side connector (not shown), which is located in an inner portion of a housing of the electrical storage device. At this time, if there is a tolerance on the rail member or the like, it may be difficult to fit the second connector 840 into the electrical storage device-side connector. Accordingly, the second connector 840 is formed in such a way as to be able to slightly shift its position, thereby covering such a tolerance.

FIG. 3 is a diagram for explaining how the second connector 840 is mounted on a connector mounting panel 847. FIG. 4 is a diagram for explaining how the connector mounting panel 847 is mounted on the assembled battery housing chassis 800.

At both ends of a body portion 841 of the second connector 840, two through-holes (not shown in FIG. 3) are provided. Bushes 844 are placed in the two through-holes. The outer diameter of the bushes 844 is smaller than the inner diameter of the through-holes by 2Δb. Therefore, the body portion 841 of the second connector 840 can move within the range of 2Δb with respect to the bushes 844.

The second connector 840 is fitted into a connector mounting opening portion 848 of the connector mounting panel 847. The second connector 840 is firmly attached to the connector mounting panel 847 by means of mounting screws 850 that are inserted and screwed into connector mounting screw holes 849 of the connector mounting panel 847, bushes 844, and female screw holes 853 of a fastening member 852. Accordingly, the second connector 840 can move within the range of 2Δb with respect to the connector mounting panel 847.

On both sides of a second connector mounting opening portion 832, panel mounting screw holes 834 are provided; the panel mounting screw holes 834 are used to attach the connector mounting panel 847 to the assembled battery housing chassis 800.

The outer diameter of annular members 835 that are inserted into mounting cutout portions 851, which are located in both ends of the connector mounting panel 847, are smaller than the inner side portions of the mounting cutout portions 851 by 2Δa. Therefore, the connector mounting panel 847 can move within the range of 2Δa with respect to the assembled battery housing chassis 800.

The connector mounting panel 847 on which the second connector 840 has been mounted is attached to the assembled battery housing chassis 800 by means of mounting screws 836, which are inserted into the connector mounting screw holes 849, retaining washers 837, mounting cutout portions 851, and panel mounting screw holes 834.

The connector mounting panel 847 is able to move within the range of 2Δa with respect to the assembled battery housing chassis 800. Furthermore, the second connector 840 is able to move within the range of 2Δb with respect to the connector mounting panel 847. Accordingly, the second connector 840 can move within the range of 2Δa+2Δb with respect to the assembled battery housing chassis 800. In this case, dimensional relation Δa>Δb is set. As a result, the second connector 840 of the battery module 1000 whose position is regulated by the rail member when being guided can be more smoothly fitted into the electrical storage device-side connector.

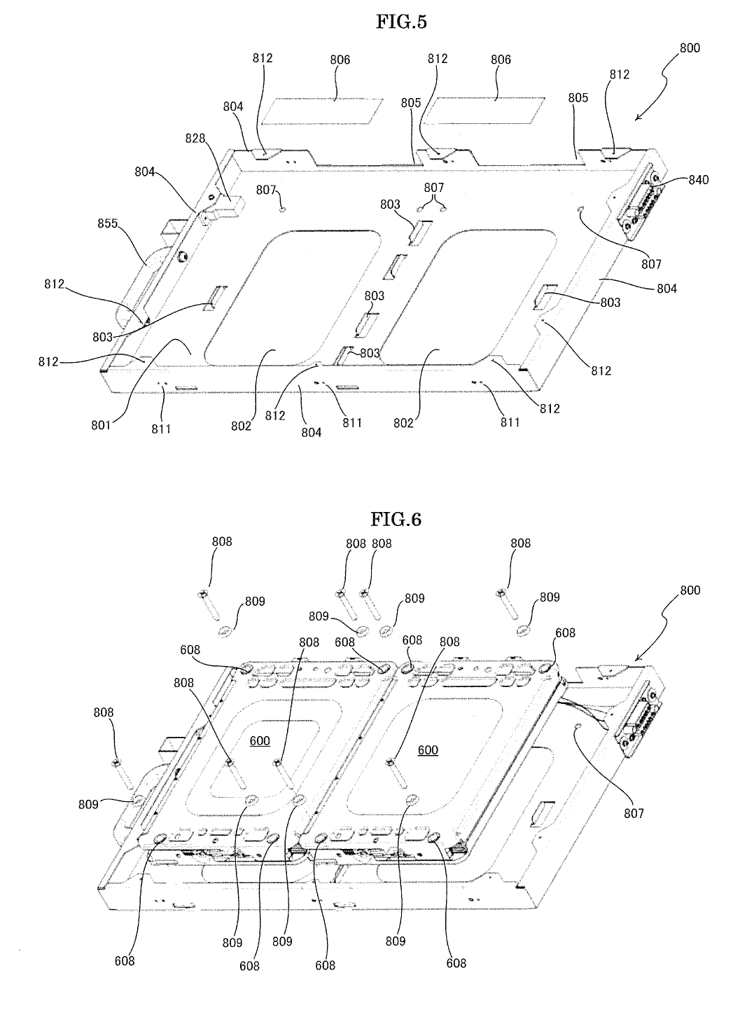

FIG. 5 shows a process of placing insulating paper 806 on the assembled battery housing chassis 800 on which the first connector 828, handle portion 855, and second connector 840 have been mounted as described above.

On a first main surface 801 of the stainless-steel assembled battery housing chassis 800, two opening portions 802 are provided in such a way as to correspond to two assembled batteries 600, which will be mounted later. On the first main surface 801, a plurality of cut-and-raised pieces 803, which are made by cutting and raising portions of the first main surface 801, are provided. The cut-and-raised pieces 803 regulate the positions of the assembled batteries 600.

On the periphery of the first main surface 801, a peripheral erected portion 804, which is formed by bending, is formed. In the peripheral erected portion 804, guide member mounting screw holes 811, cover mounting screw holes 812, and the like are provided. The peripheral erected portion 804 has areas where two cutout portions 805 are provided. The cutout portions 805 make the attachment of power lines easier.

FIG. 6 shows a process of fixing the assembled batteries 600 to the assembled battery housing chassis 800. During the process, mounting screws 808 are inserted into rosette washers 809 and fixation through-holes 608 of the assembled batteries 600. Then, the mounting screws 808 are screwed into assembled battery mounting screw holes 807. As a result, the assembled batteries 600 are fixed to the assembled battery housing chassis 800.

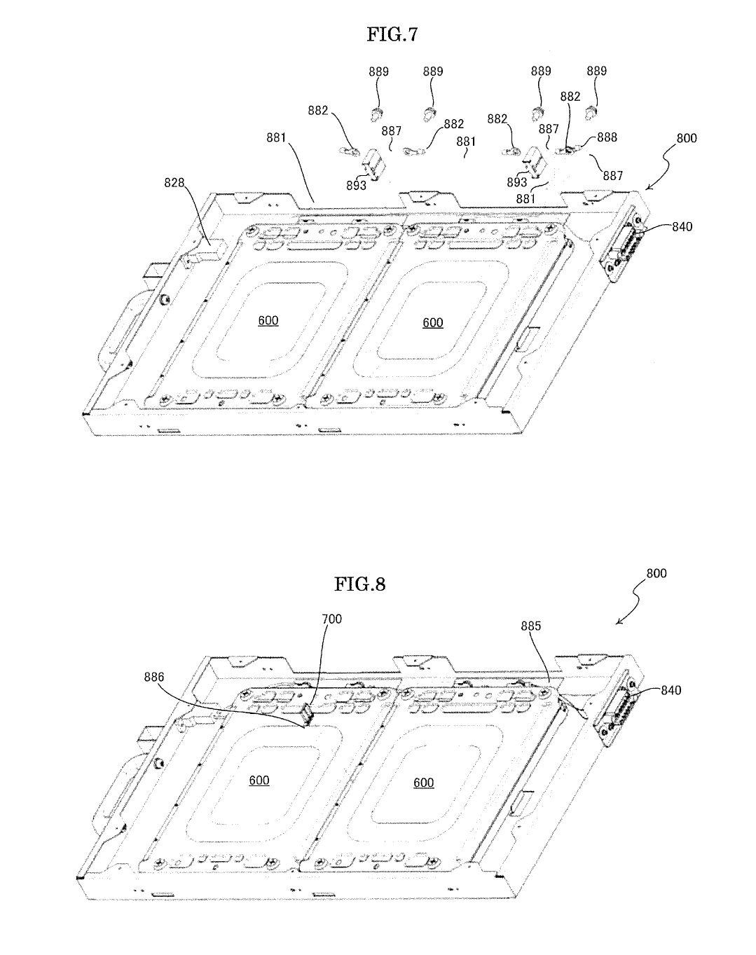

FIG. 7 shows a process of carrying out electrical wiring for the assembled batteries 600 mounted on the assembled battery housing chassis 800.

To the first connector 828 and a terminal of the assembled battery 600, a power line 881 is electrically connected. As a result, via the first connector 828, potential of the two assembled batteries 600 that are connected in series can be taken out. Incidentally, a power line terminal 882 of the power line 881 and a screw 889 are used.

A sense line 887 is attached at the same time in order to monitor potential of the right assembled battery 600 (potential of the battery module 1000). This potential can be taken out via the second connector 840.

The unit battery voltage take-out connector portion 609 of each assembled battery 600 is coupled to a unit battery voltage take-out connector 893. The unit battery voltage take-out connector 893 is electrically connected to the second connector 840. As a result, voltage information of the unit batteries 100 that make up each assembled battery 600 can be acquired via the second connector 840.

FIG. 8 shows a process of mounting a temperature sensor 886. The temperature sensor 886 is electrically connected to the second connector 840 via a temperature sensor connection line 885. The temperature sensor 886 is housed in a holder 700 that is made of resin, before being mounted. The resin holder 700 is pressed into an almost middle point between the two assembled batteries 600 as the resin holder 700 is mounted.

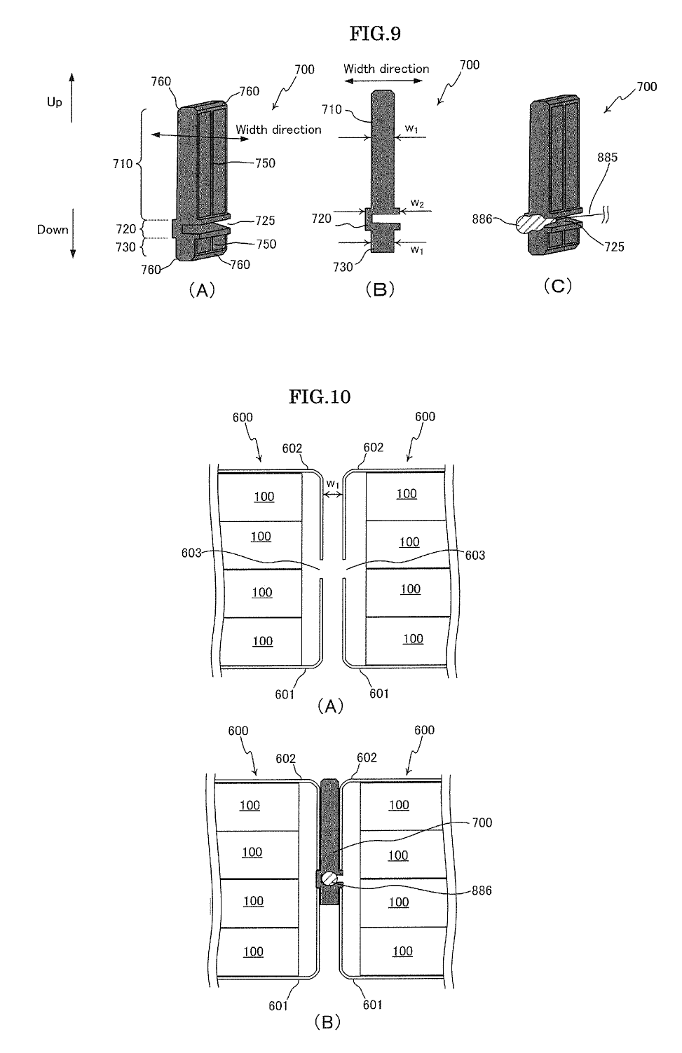

The holder 700 that houses the temperature sensor 886 will be described in detail. FIG. 9 is an explanatory diagram showing an overview of the holder 700. FIG. 9A is a perspective view of the holder not housing the temperature sensor 886. FIG. 9B is a front view of the holder not housing the temperature sensor 886. FIG. 9C is a perspective view of the holder housing the temperature sensor 886.

The resin holder 700 includes, from top to bottom, an upper narrow portion 710 whose width is w₁, a wide portion 720 whose width is w₂ and is wider than w, and a lower narrow portion 730 whose width is w₁.

Width w₁ of the upper narrow portion 710 and lower narrow portion 730 is set equal to the distance between the case bodies of the two assembled batteries 600 mounted on the assembled battery housing chassis 800 (Refer to FIG. 10A).

Width w₂ of the wide portion 720 is wider than the distance between the case bodies of the two assembled batteries 600 mounted on the assembled battery housing chassis 800. When passing between the case bodies, the wide portion 720 widens the space between the case bodies. Accordingly, width w₂ of the wide portion 720 is set to a length that enables elastic deformation of the case bodies and the like to absorb an increase in the width of the space between the case bodies.

On the upper surface of the upper narrow portion 710 and on the lower surface of the lower narrow portion 730, tapered portions 760 are provided. The tapered portions 760 make the installation of the holder 700 between the case bodies of the two assembled batteries 600 easier. In the upper narrow portion 710 and the lower narrow portion 730, ribs 750 are provided for reinforcement.

In the wide portion 720, a slit-like temperature sensor holding gap portion 725 is provided. As a result, as shown in FIG. 9C, the temperature sensor 886, such as thermistor, can be held and housed.

Here is a description of how the temperature sensor 886 housed in the above holder 700 is disposed between the case bodies of the two assembled batteries 600. FIG. 10 is a diagram for explaining how the temperature sensor 886 is arranged in the battery module 1000 according to the embodiment of the present invention. FIG. 10 is a schematic cross-sectional view of a portion where the temperature sensor 886 is disposed in a direction in which the unit batteries 100 are stacked in the assembled batteries 600. FIG. 10A shows the situation before the holder 700 is mounted. FIG. 10B shows the situation after the holder 700 is mounted.

As shown in FIG. 10B, the battery module 1000 of the present embodiment includes two of the assembled batteries 600 in which four unit batteries 100 are sandwiched between two case bodies. In the assembled battery 600, the slit portion 603 is provided. Between the slit portion 603 of one assembled battery 600 and the slit portion 603 of the other assembled battery 600, the temperature sensor 886 is disposed.

As shown in FIG. 10B, the temperature sensor 886 is housed in the holder 700. The holder 700 is fixed after being fitted into both the slit portion 603 of one assembled battery 600 and the slit portion 603 of the other assembled battery 600.

In the above-described battery module 1000 of the present invention, a layout of temperature sensors 886 that can accurately detect the average of entire temperature information from all the unit batteries 100 that make up the battery module 1000 can be realized by a small number of temperature sensors 886. As a result, it is possible to curb an increase in the number of parts and achieve a reduction in costs. Moreover, the first case body 601 and the second case body 602 are firmly fixed to the assembled battery housing chassis 800 with a plurality of mounting screws 808 near the outer periphery of the assembled battery 600. Therefore, even if the central portion of the assembled battery 600 swells due to the swelling of the unit batteries 100, an expansion in a portion where the slit portion 603 is provided is suppressed. In this manner, even if the unit batteries 100 swell, the positional relation between the temperature sensor 886 and the assembled batteries 600 in thickness direction is unlikely to change. Therefore, the temperature can be accurately detected.

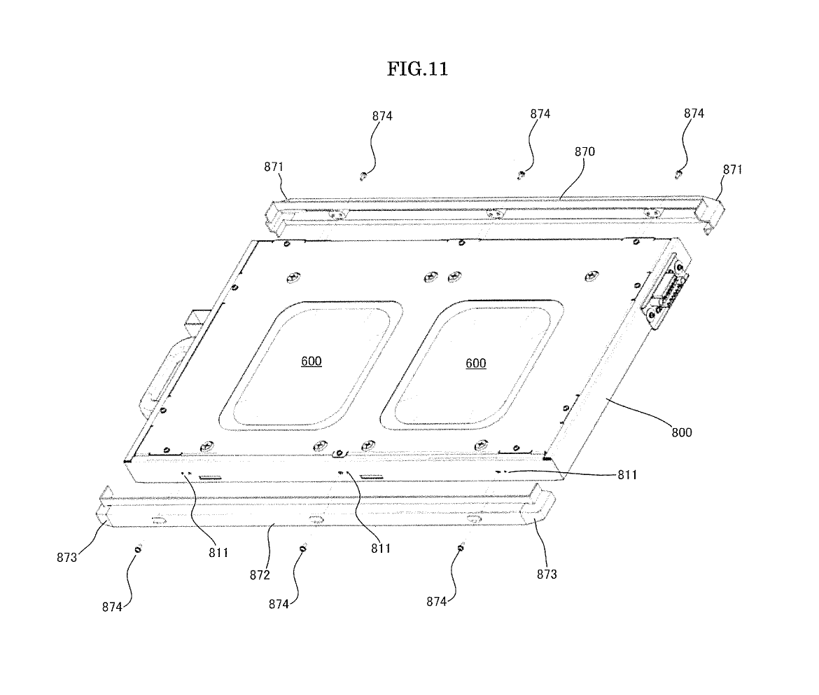

FIG. 11 shows a process of attaching guide members, which face, come in contact with and slide on concave rail members at a time when the battery module 1000 is fitted into an electrical storage device-side connector (not shown) located in an inner portion of a housing of the electrical storage device (not shown) while the position thereof is being regulated by the concave rail members (not shown).

A first end side protruding guide member 870 and a second end side protruding guide member 872 are respectively fixed to one end of the assembled battery housing chassis 800 and the other end, as guide member mounting screws 874 are screwed into guide member mounting screw holes 811 that are provided in the peripheral erected portion 804 of the assembled battery housing chassis 800.

Tapered portions 871 are provided in both end portions of the first end side protruding guide member 870. Tapered portions 873 are provided in both end portions of the second end side protruding guide member 872. The tapered portions help improve the handling of the battery module 1000 as the tapered portions make it easier to insert the battery module 1000 into the concave rail members as described above. Moreover, when the battery module 1000 is removed from the concave rail members, there is some play in each of the tapered portions. Therefore, a user does not have to pay much attention to the direction in which the battery module 1000 is pulled, and the handling of the battery module is therefore improved.

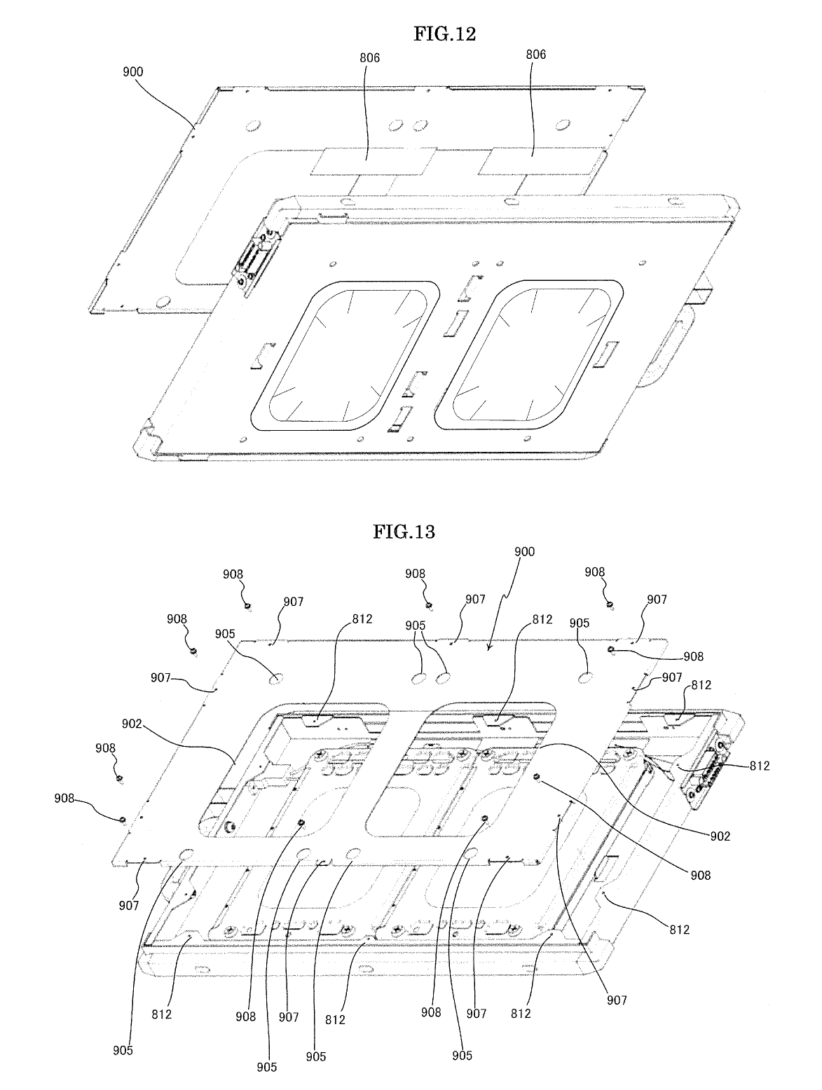

FIG. 12 shows a process of placing insulating paper 806 on a chassis cover 900, which is attached to the assembled battery housing chassis 800. The chassis cover 900 is attached to the assembled battery housing chassis 800 in such a way as to cover wires such as power lines 881.

FIG. 13 shows a process of attaching the chassis cover 900 to the assembled battery housing chassis 800.

The chassis cover 900 has assembled battery opening portions 902, which are openings for the two assembled batteries 600 mounted on the assembled battery housing chassis 800; and screw opening portions 905, which are openings for the mounting screws 808 that are used to mount the assembled batteries 600.

The chassis cover 900 is mounted on the assembled battery housing chassis 800 as mounting screws 908 are inserted into mounting screw holes 907, which are provided on the periphery of the chassis cover 900, and then are screwed into cover mounting screw holes 812 of the assembled battery housing chassis 800.

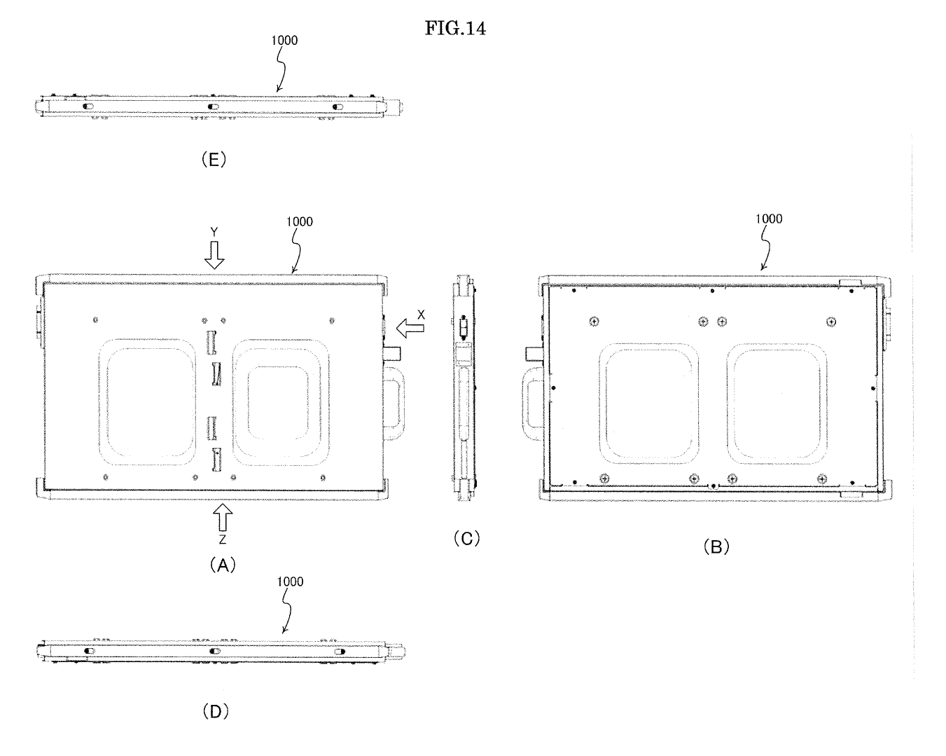

FIG. 14 shows the battery module 1000 of the present embodiment, which is produced by a series of processes described above.

FIG. 14A is a view of the batter module 1000 when seen from one main surface side. FIG. 14B is a view of the batter module 1000 when seen from the other main surface side. FIG. 14C is a view of the battery module 1000 when seen from X of FIG. 14A. FIG. 14D is a view of the battery module 1000 when seen from Y of FIG. 14A. FIG. 14E is a view of the battery module 1000 when seen from Z of FIG. 14A.

In the above-described battery module 1000 of the present invention, a layout of temperature sensors 886 that can accurately detect the average of entire temperature information from all the unit batteries 100 that make up the battery module 1000 can be realized by a small number of temperature sensors 886. As a result, it is possible to curb an increase in the number of parts and achieve a reduction in costs.

### INDUSTRIAL APPLICABILITY

The present invention relates to a battery module formed by using secondary unit batteries such as lithium-ion batteries. As for such a battery module, demand for high-capacity ones is increasing. What has been used is a plurality of assembled batteries that are connected in series or parallel, with each assembled battery made up of a plurality of unit batteries being connected. One way to find how much a battery has deteriorated is to measure temperatures. In the conventional one, a temperature sensor is provided for each of a plurality of secondary batteries in order to detect their temperatures. The problem is that such a configuration leads to an increase in the number of parts and a rise in costs. According to the present invention, a slit portion is provided in an assembled battery, and a temperature sensor is disposed between the slit portion of one assembled battery and the slit portion of another assembled battery. In the above-described battery module of the present invention, a layout of temperature sensors that can accurately detect the average of entire temperature information from all the unit batteries that make up the battery module can be realized by a small number of temperature sensors. As a result, it is possible to curb an increase in the number of parts and achieve a reduction in costs. Thus, the battery module is very high in industrial applicability.

### EXPLANATION OF REFERENCE SYMBOLS

100: Unit battery
600: Assembled battery
601: First case body
602: Second case body
603: Slit portion
604: Assembled battery plus terminal
605: Assembled battery minus terminal
606: Screw hole
607: Screw hole
608: Fixation through-hole
609: Unit battery voltage take-out connector portion
700: Holder
710: Upper narrow portion
720: Wide portion
725: Temperature sensor holding gap portion
730: Lower narrow portion
750: Rib
760: Tapered portion
800: Assembled battery housing chassis
801: First main surface
802: Opening portion
803: Cut-and-raised piece
804: Peripheral erected portion
805: Cutout portion
806: Insulating paper
807: Assembled battery mounting screw hole
808: Mounting screw
809: Rosette washer
811: Guide member mounting screw hole
812: Cover mounting screw hole
813: Connector mounting screw hole
814: Handle mounting screw hole
825: First connector mounting opening portion
828: First connector
829: Mounting screw
832: Second connector mounting opening portion
834: Panel mounting screw hole
835: Annular member
836: Mounting screw
837: Retaining washer
840: Second connector
841: Body portion
844: Bush
847: Connector mounting panel
848: Connector mounting opening portion
849: Connector mounting screw hole
850: Mounting screw
851: Mounting cutout portion
852: Fastening member
853: Female screw hole
855: Handle portion
856: Mounting screw
870: First end side protruding guide member
871: Tapered portion
872: Second end side protruding guide member
873: Tapered portion
874: Guide member mounting screw
881: Power line
882: Power line terminal
885: Temperature sensor connection line
886: Temperature sensor
887: Sense line
888: Sense line terminal
889: Screw
893: Unit battery voltage take-out connector
900: Chassis cover
902: Assembled battery opening portion
905: Screw opening portion
907: Mounting screw hole
908: Mounting screw
1000: Battery module

1. A battery module characterized by comprising
a plurality of assembled batteries in which a plurality of unit batteries are sandwiched between two case bodies, wherein
slit portions are provided in the assembled batteries, and
a temperature sensor is disposed between the slit portion of one of the assembled batteries and the slit portion of the other assembled battery.

2. The battery module according to claim 1, characterized in that
the temperature sensor is housed in a temperature sensor holder, and the temperature sensor holder is fixed as the temperature sensor holder is fitted into both the slit portion of one of the assembled batteries and the slit portion of the other assembled battery.

3. The battery module according to claim 1, characterized in that
the slit portion is space between the two case bodies.

4. The battery module according to claim 2, characterized in that the slit portion is space between the two case bodies.
